(19) United States
(12) Patent Application Publication
(10) Pub. No.: US 2025/0100312 A1
(43) Pub. Date: Mar. 27, 2025

(54) PRINTING APPARATUS, METHOD, AND STORAGE MEDIUM STORING PROGRAM

(71) Applicant: CANON KABUSHIKI KAISHA, Tokyo (JP)

(72) Inventor: Takashi Sawada, Saitama (JP)

(21) Appl. No.: 18/895,531

(22) Filed: Sep. 25, 2024

(30) Foreign Application Priority Data
Sep. 27, 2023 (JP) 2023-166222

(51) Int. Cl. B41J 29/393; B41J 29/48

(52) U.S. Cl. CPC B41J 29/393; B41J 29/48

(57) ABSTRACT

A printing apparatus includes: a plurality of sheet housing units; and a notification unit configured to, in a case where, in printing, a sheet is supplied from a first sheet housing unit included in the plurality of sheet housing units, make a notification of a message prompting that a user operation not be performed on a second sheet housing unit different from the first sheet housing unit. In a case where the second sheet housing unit is operated by a user, a path that the second sheet housing unit passes overlaps with at least a portion of a conveyance path of the sheet supplied from the first sheet housing unit.

### BACKGROUND OF THE INVENTION

### Field of the Invention

The present invention relates to a printing apparatus including a sheet housing unit, a method in that printing apparatus, and a storage medium storing a program.

### Description of the Related Art

Japanese Patent Laid-Open No. 2007-276315 Publication 1 describes a display unit configured to provide information related to a jam to a user, jam release processing being performed by the user when a jam occurs, and performing control for prohibiting operation by locking a device when a jam occurs.

In a case of printing apparatuses that do not include a locking mechanism, a jam may occur if another feeding cassette is opened and closed during printing performed by feeding paper from a particular feeding cassette. Japanese Patent Laid-Open No. 2007-276315 Publication 1 does not mention preventing occurrence of a jam in a printing apparatus that does not include a locking mechanism.

### SUMMARY OF THE INVENTION

The present invention provides a printing apparatus that prevents an event that hinders printing from being caused by an operation on a sheet housing unit being performed, and a method in that printing apparatus, and a storage medium storing a program.

The present invention in its first aspect provides a printing apparatus comprising: a plurality of sheet housing units; and a notification unit configured to, in a case where, in printing, a sheet is supplied from a first sheet housing unit included in the plurality of sheet housing units, make a notification of a message prompting that a user operation not be performed on a second sheet housing unit different from the first sheet housing unit, wherein in a case where the second sheet housing unit is operated by a user, a path that the second sheet housing unit passes overlaps with at least a portion of a conveyance path of the sheet supplied from the first sheet housing unit.

The present invention in its second aspect provides a method to be executed in a printing apparatus including a plurality of sheet housing units, the method comprising: in a case where, in printing, a sheet is supplied from a first sheet housing unit included in the plurality of sheet housing units, making notification of a message prompting that a user operation not be performed on a second sheet housing unit different from the first sheet housing unit, wherein in a case where the second sheet housing unit is operated by a user, a path that the second sheet housing unit passes overlaps with at least a portion of a conveyance path of the sheet supplied from the first sheet housing unit.

The present invention in its third aspect provides a non-transitory computer-readable storage medium that stores one or more programs including instructions, which when executed by one or more processors of an information processing apparatus, cause the information processing apparatus to perform a method, the method comprising: in a case where, in printing, a sheet is supplied from a first sheet housing unit included in a plurality of sheet housing units, making notification of a message prompting that a user operation not be performed on a second sheet housing unit different from the first sheet housing unit, wherein in a case where the second sheet housing unit is operated by a user, a path that the second sheet housing unit passes overlaps with at least a portion of a conveyance path of the sheet supplied from the first sheet housing unit.

According to the present invention, it is possible to prevent an event that hinders printing from being caused by an operation on a sheet housing unit being performed.

Further features of the present invention will become apparent from the following description of exemplary embodiments with reference to the attached drawings.

### BRIEF DESCRIPTION OF THE DRAWINGS

FIG. 1 is a diagram illustrating an example of an internal configuration of a printing apparatus.

FIG. 2 is a block diagram illustrating a control configuration of the printing apparatus.

FIGS. 3A and 3B are diagrams for explaining front surface conveyance and occurrence of a jam.

FIG. 4 is a flowchart for explaining processing to be executed in the printing apparatus.

FIG. 5 is a diagram illustrating a message screen.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

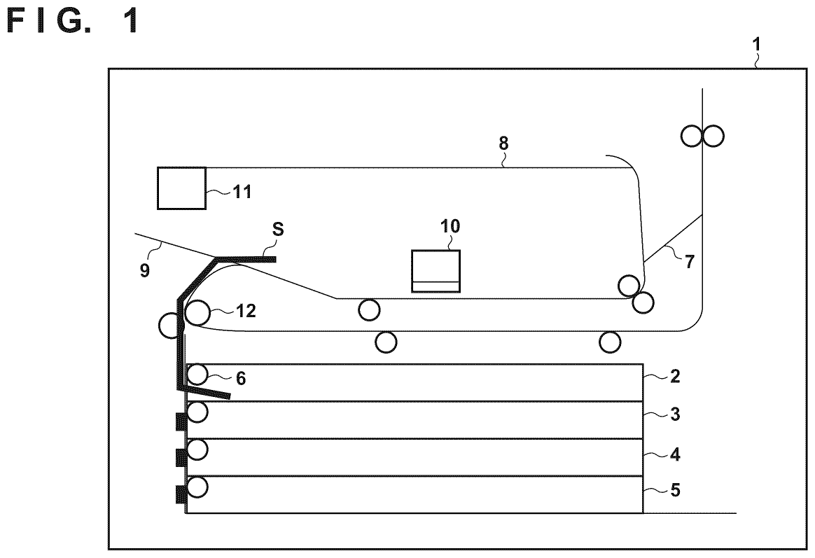

FIG. 1 is a diagram illustrating an example of an internal configuration of an inkjet printing apparatus 1 (hereinafter, referred to as printing apparatus 1) used in the present embodiment. The printing apparatus 1 is an apparatus including a printing unit but may be in a form including a function as a multifunction peripheral including a scanner unit. Further, as will be described below, the printing apparatus 1 is configured to include four feeding cassettes having a vertical positional relationship with each other, but there need not be four feeding cassettes; there may be one, five, or more feeding cassettes. The left side in the drawing is a front surface of the printing apparatus 1, and a user can pull out each feeding cassette to the left side in the drawing, that is, a user side.

A configuration is taken such that a feeding cassette 2 is an uppermost feeding cassette, a feeding cassette 3 is below the feeding cassette 2, a feeding cassette 4 is further below, and a feeding cassette 5 is in a lowermost portion. Each of the feeding cassettes 2 to 5 is configured such that a housing portion for housing a printing medium such as a sheet can be slid and pulled out from a housing of the printing apparatus 1. Hereinafter, unless otherwise specified, the feeding cassette 2 will be described as a representative example of the feeding cassettes 2 to 5.

Inside the printing apparatus 1, a feeding roller 6 and conveyance rollers 12 are configured to convey a sheet through a conveyance path from supply of the sheet from the feeding cassette 2 until discharge of the sheet, and the feeding roller 6 is used when picking up a sheet stacked in the feeding cassette 2. A print head 10 is a printing unit that performs printing on a sheet by discharging ink droplets from a nozzle row corresponding to a color that can be printed by the printing apparatus 1. The print head 10 may be a so-called serial print head that can move back and forth in a direction orthogonal to a sheet conveyance direction or may be a so-called line print head that is configured across a sheet width direction.

For example, when the feeding cassette 2 is selected and printing is started while a sheet is housed in the feeding cassette 2, the sheet is picked up by the feeding roller 6, which is mounted in the feeding cassette 2, and is fed to the conveyance path. A sheet S fed to the conveyance path is conveyed through the conveyance path, and printing that is based on print data is performed by the print head 10. In a case of single-sided printing, a sheet S on which printing has been performed is conveyed through a discharge path 8 and is discharged in a state (faced down) in which the surface on which printing has been performed faces down. Meanwhile, in a case of double-sided printing, a sheet S on which printing has been performed is conveyed through a double-sided path via a reversing path 7, and printing that is based on print data is performed again by the print head 10 on a back surface. Then, the sheet is conveyed and discharged through the discharge path 8.

Regarding the printing apparatus 1, a tray capable of supplying a sheet to the conveyance path may be configured in addition to the feeding cassettes 2 to 5. For example, a type of printing medium desired by the user can be set on a manual feeding tray 9, and that printing medium can be supplied to the conveyance path. In the present embodiment, it is assumed that the manual feeding tray 9 is positioned such that a user can set a printing medium on the manual feeding tray 9 by manual feeding from the front surface side of the printing apparatus 1. However, the manual feeding tray 9 is not limited to this form and, for example, may be positioned such that the user can set a printing medium on the manual feeding tray 9 by manual feeding from a back side (side opposite to the front surface side) of the printing apparatus 1. An operation panel 11 is configured to be capable of accepting an input/output operation to the printing apparatus 1 by a user. The user can instruct an operation such as copying or scanning or set a printing mode via the operation panel 11. Further, the operation panel 11 operates as a display unit for displaying each piece of information of the printing apparatus 1. The operation panel 11 may include a physical key or may be configured as a touch panel.

The printing apparatus 1 in the present embodiment is a front-surface-conveyance-type printing apparatus, and a sheet conveyance operation will be described later.

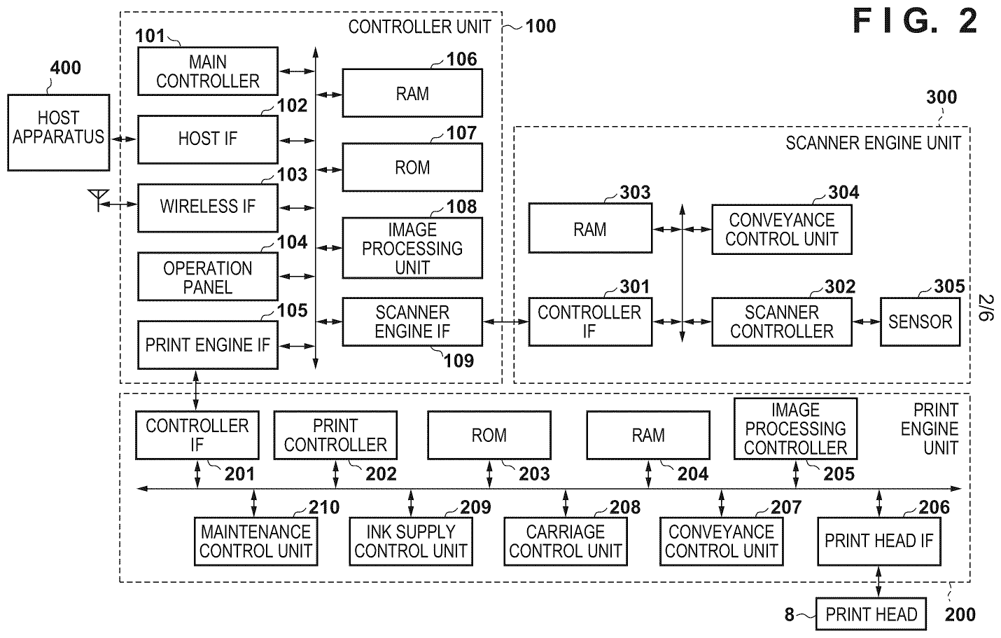

FIG. 2 is a block diagram illustrating a control configuration of the printing apparatus 1. The control configuration is configured to include a print engine unit 200 for mainly controlling a print operation, a scanner engine unit 300 for controlling a scanner operation, and a controller unit 100 for controlling the entire printing apparatus 1. A print controller 202 controls various mechanisms of the print engine unit 200 according to instructions of a main controller 101 of the controller unit 100. Various mechanisms of the scanner engine unit 300 are controlled by the main controller 101 of the controller unit 100. The control configuration will be described in detail below.

In the controller unit 100, the main controller 101 configured to include a CPU controls the entire printing apparatus 1 according to a computer program and various parameters stored in a ROM 107, while using a RAM 106 as a work area. For example, when a print job is inputted via a network from an external host apparatus 400, such as a PC, via a host I/F 102 or a wireless I/F 103, an image processing unit 108 executes predetermined image processing on received image data according to an instruction of the main controller 101. The main controller 101 transmits the image data on which the image processing has been executed to the print engine unit 200 via a print engine I/F 105.

The printing apparatus 1 may obtain image data from the host apparatus 400 via wireless communication or wired communication or may obtain image data from an external storage apparatus (USB memory, etc.) connected to the printing apparatus 1. Communication methods to be used for wireless communication and wired communication are not particularly limited. For example, as the communication method to be used for wireless communication, Wireless Fidelity (Wi-Fi)® or Bluetooth® may be used. In addition, Universal Serial Bus (USB) and the like can be adopted as the communication method to be used for wired communication. In addition, when a read command is inputted from the host apparatus 400, the main controller 101 transmits the read command to the scanner engine unit 300 via a scanner engine I/F 109.

An operation panel 104 is a mechanism for accepting input/output to the printing apparatus 1 from the user and corresponds to the operation panel 11 of FIG. 1. As input/output operations from the user, there are, for example, an operation instruction such as copying or scanning via the operation panel 104 and setting of a plurality of printing modes including color printing, monochrome printing, and the like. The operation panel 104 can display various user interface screens.

In the print engine unit 200, the print controller 202 configured to include a CPU controls various mechanisms of the print engine unit 200 according to a program and various parameters stored in a ROM 203, using a RAM 204 as a work area. Upon receiving various commands and image data via a controller I/F 201, the print controller 202 temporarily stores them in the RAM 204. The print controller 202 controls an image processing controller 205 so as to convert the stored image data to print data such that the print head 10 can perform a printing operation. When the print data is generated by the conversion, the print controller 202 causes the print head 10 to execute a printing operation via a print head I/F 206. At that time, the print controller 202 drives the conveyance rollers 12 and the feeding roller 6 via a conveyance control unit 207 to convey a printing medium S. According to an instruction of the print controller 202, a printing operation by the print head 10 is executed in conjunction with a conveyance operation of the printing medium S, and print processing is performed.

A carriage control unit 208 changes the orientation and position of the print head 10 according to an operation state such as a maintenance state or a printing state of the printing apparatus 1. An ink supply control unit 209 controls an ink supply unit (not illustrated) such that the pressure of ink supplied to the print head 10 is within an appropriate range. A maintenance control unit 210 controls operations of a cap unit (not illustrated) and a wiping unit (not illustrated) when performing a maintenance operation for the print head 10.

In the scanner engine unit 300, the main controller 101 controls hardware resources of a scanner controller 302 according to a program and various parameters stored in the ROM 107, using the RAM 106 as a work area. With this, various mechanisms provided in the scanner engine unit 300 are controlled. For example, the main controller 101 controls the hardware resources within the scanner controller 302 via a controller I/F 301. Accordingly, a document set on an Automatic Document Feeder (ADF) by the user is conveyed through the conveyance control unit 304 and is read by a sensor 305. Then, the scanner controller 302 stores, in the RAM 303, image data generated by reading the document. By converting the image data obtained as described above to print data, the print controller 202 can cause the print head 10 to execute a printing operation that is based on the image data read by the scanner controller 302. The printing apparatus 1 is not limited to the configurations illustrated in FIGS. 1 and 2 and may appropriately include functional blocks that can be executed by a device used as the printing apparatus 1.

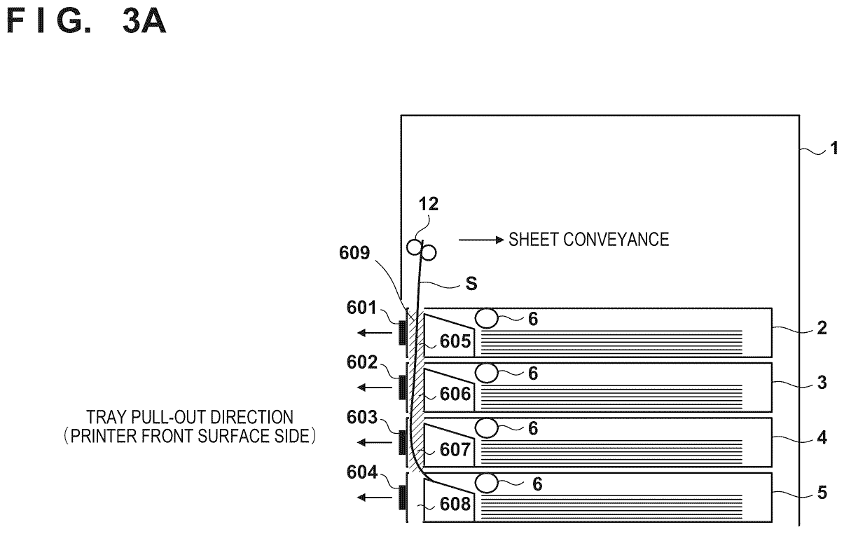

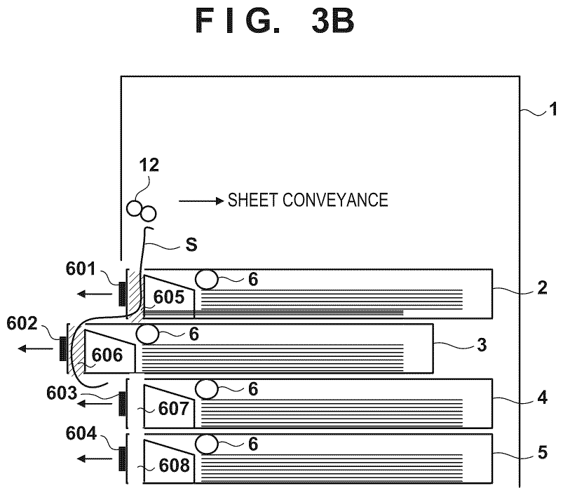

FIGS. 3A and 3B are diagrams for explaining a conveyance operation of a sheet picked up in a feeding cassette of the printing apparatus 1. In the printing apparatus 1, front-surface-conveyance-type sheet conveyance is performed. In the front-surface-conveyance-type sheet conveyance, a sheet picked up in a feeding cassette is conveyed to the print head 10 through a pull-out side, that is, the front surface side of the printing apparatus 1.

FIG. 3A illustrates a state in which the feeding cassettes 2 to 5 are provided in the printing apparatus 1. The feeding cassette 2 is slidable in an arrow direction by a pull-out operation of a handle 601 by the user. That is, in other words, the front surface of the printing apparatus 1 is a surface on which the handle 601 is provided among surfaces of the printing apparatus 1 and is a surface positioned in a direction in which the feeding cassette 2 is pulled out. The feeding cassette 3 is slidable in an arrow direction by a pull-out operation of a handle 602 by the user. The feeding cassette 4 is slidable in an arrow direction by a pull-out operation of a handle 603 by the user. The feeding cassette 5 is slidable in an arrow direction by a pull-out operation of a handle 604 by the user. Further, in the printing apparatus 1 in the present embodiment, the respective feeding cassettes are not provided with a locking mechanism for prohibiting the feeding cassette from being pulled out, and so, even when printing on a sheet serving as a printing medium is being performed, the feeding cassette can be pulled out. A configuration in which a locking mechanism is provided for each feeding cassette may be taken. However, even in such a configuration, in a state in which a respective feeding cassette is not locked by a locking mechanism, the feeding cassette can be pulled out even when printing on a sheet serving as a printing medium is being performed. Printing here includes a conveyance operation in which a sheet picked up from a feeding cassette is conveyed to the print head 10.

FIG. 3A illustrates a state in which a sheet picked up in the feeding cassette 5 is being conveyed to the print head 10 through the conveyance rollers 12. In each feeding cassette, a space is provided near an inner wall of the feeding cassette on the front surface side of the printing apparatus 1. For example, in FIG. 3A, in the feeding cassette 2, a space 605 is provided near an inner wall of the feeding cassette on the front surface side of the printing apparatus 1. In the feeding cassette 3, a space 606 is provided near an inner wall of the feeding cassette on the front surface side of the printing apparatus 1. In the feeding cassette 4, a space 607 is provided near an inner wall of the feeding cassette on the front surface side of the printing apparatus 1. In the feeding cassette 5, a space 608 is provided near an inner wall of the feeding cassette on the front surface side of the printing apparatus 1. A sheet picked up in a respective feeding cassette is pushed upward through the above-described space by a conveyance force of the feeding roller 6 and is conveyed to the print head 10. FIG. 3A illustrates a state in which a sheet picked up in the feeding cassette 5 is pushed upward to the conveyance rollers 12 through the spaces 605 to 607 by the conveyance force of the feeding roller 6 and then is conveyed to the print head 10. That is, as illustrated in the example of FIG. 3A, the spaces 605 to 607, as indicated by hatching, form a portion 609 of the sheet conveyance path.

FIG. 3B is a diagram for explaining that a jam occurs when the user pulls out a feeding cassette during feeding. When a job set such that paper is fed from the feeding cassette 5 is executed, a sheet S is conveyed through the portion 609 of the conveyance path as illustrated in FIG. 3A. Here, assume that, for example, while the sheet picked up from the feeding cassette 5 is passing through the spaces 605 to 607, the user performs an operation to pull out the feeding cassette 3. In that case, as illustrated in FIG. 3B, the portion 609 of the conveyance path is severed, a jam of the sheet S occurs, and printing is hindered. That is, a path that is a movement path of an upper feeding cassette and is a path through which the upper feeding cassette passes when the upper feeding cassette is pulled out by the user overlaps with at least a portion of the conveyance path of a sheet fed from a lower feeding cassette.

In order to prevent such a situation, it is conceivable that a physical locking mechanism be provided so as to prevent the user from pulling out a feeding cassette during printing. However, a configuration for control of the locking mechanism is necessary. Further, instead of front-surface-conveyance-type sheet conveyance, it is conceivable that a conveyance path be provided on a back surface of the printing apparatus 1. However, in that case, an advantage of the front-surface-conveyance-type sheet conveyance that the conveyance path to the print head 10 can be shortened is lost.

In the present embodiment, when there is a possibility that an event that hinders printing such as a jam will occur, a message screen prompting the user not to pull out a feeding cassette different from a feeding cassette from which a sheet is picked up is displayed. With this, it is possible to prevent a jam or the like from occurring due to an unintentional pull-out operation of a feeding cassette of the user.

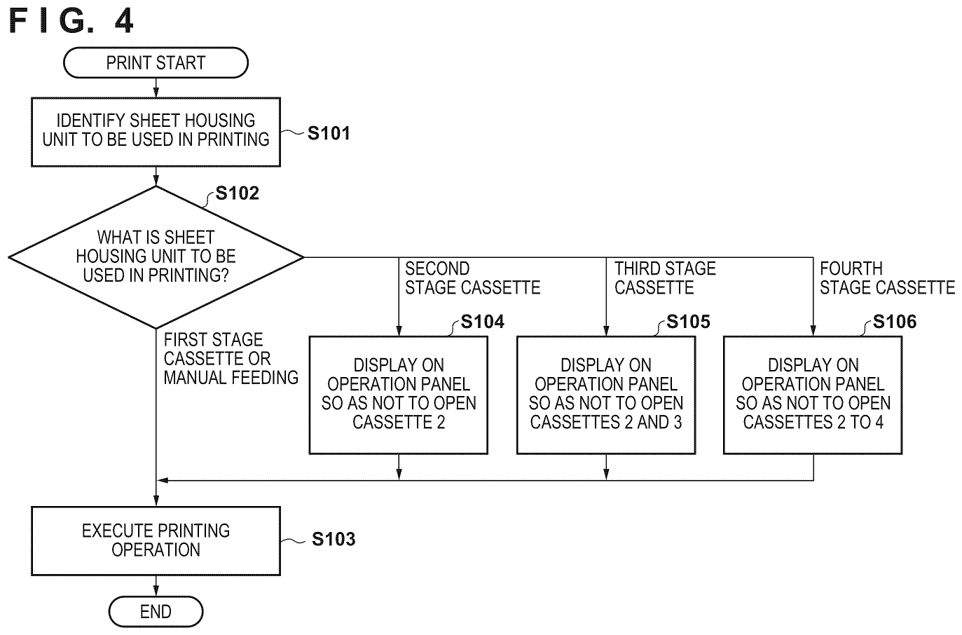

FIG. 4 is a flowchart for explaining notification processing to be executed in the printing apparatus 1 so as to prevent the user from pulling out a feeding cassette during printing. The processing of FIG. 4 is realized, for example, by the main controller 101 reading out a program stored in the ROM 107 to the RAM 106 and executing the program. The processing of FIG. 4 is started, for example, when the operation panel 104 accepts a user instruction for executing copying, printing, or the like.

When a printing operation is started, in step S101 the main controller 101 identifies which of the sheet housing units is to be used in printing. Here, the sheet housing units include the feeding cassettes 2 to 5 and the manual feeding tray 9. For example, the main controller 101 obtains information of a sheet housing unit designated by the user on the operation panel 104. Alternatively, the main controller 101 obtains information of a sheet housing unit set in a job. Further, for example, a feeding cassette storing a sheet that matches a sheet size selected by the user may be identified as a sheet housing unit to be used in printing.

In step S102, the main controller 101 determines the sheet housing unit identified in step S101. Then, the processing is switched according to that determination result. If the identified sheet housing unit is a first stage (uppermost stage) cassette, that is, the feeding cassette 2 or the manual feeding tray 9, the processing proceeds to step S103. In step S103, the main controller 101 feeds a sheet from the identified sheet housing unit and performs printing without executing control for preventing the user from performing an operation on at least one sheet housing unit other than the identified sheet housing unit. This is because even if the user pulls out another feeding cassette other than the feeding cassette 2 or the manual feeding tray 9, there is no effect on sheet conveyance from the feeding cassette 2 or the manual feeding tray 9. As described above, in the present embodiment, when the feeding cassette 2 or the manual feeding tray 9 is identified in step S102, display control of the operation panel 104 such as those of steps S104 to S106 to be described below is not performed.

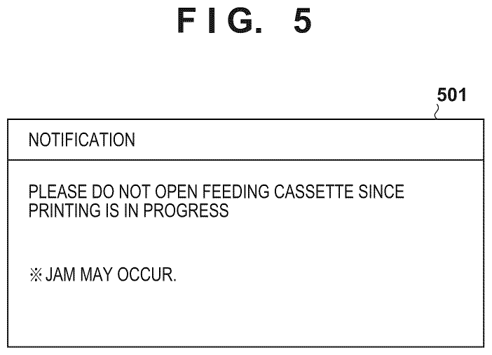

If the identified sheet housing unit is a second stage cassette, that is, the feeding cassette 3, the processing proceeds to step S104. When paper is fed from the feeding cassette 3, if the feeding cassette 2 positioned at an upper stage thereof is pulled out, the portion 609 of the conveyance path will be severed, and a jam or the like will occur. Therefore, in the present embodiment, in step S104 the main controller 101 executes first control for preventing the user from performing an operation on at least one sheet housing unit other than the identified sheet housing unit. Specifically, the main controller 101 displays a message screen as illustrated in FIG. 5 on the operation panel 104 so as to prevent the user from pulling out the feeding cassette 2. After step S104, in step S103, the main controller 101 feeds a sheet from the identified sheet housing unit and performs printing.

FIG. 5 is a diagram illustrating an example of a screen (message screen) displaying a message prompting the user not to pull out a feeding cassette. The message prompting the user not to pull out a feeding cassette is, in other words, a message prompting the user not to open a feeding cassette. As illustrated in a message 501, a message prompting that a feeding cassette not be pulled out and a message that an event that hinders printing such as a jam may occur are displayed. The message 501 may be continued to be displayed during printing or may be displayed for a predetermined time as a popup, and after the predetermined time has elapsed, the display may be terminated. Further, the display of the screen may be terminated when the user touches the operation panel 104. Further, as will be described later, in the present embodiment, a message screen is displayed in steps S104, S105, and S106, but message screens to be displayed in the respective steps may each be different. Specifically, for example, identification information of a feeding cassette that may cause a jam if operated by the user may be identified and displayed in the message 501. Specifically, identification information of the feeding cassette 2 is, for example, information indicating a name and a position of the feeding cassette 2. For example, in the case of step S104, a feeding cassette that may cause a jam if operated by the user is the feeding cassette 2. Therefore, the message 501 to be displayed in step S104 is expressed using the identification information of the feeding cassette 2. Further, the message 501 may include identification information of the sheet housing unit identified in step S101. That is, control for preventing the user from performing an operation on at least one sheet housing unit other than the identified sheet housing unit may include control for preventing the user from performing an operation on the identified sheet housing unit. Further, the screen of FIG. 5 may include a message indicating that an operation may be executed on a sheet housing unit other than a feeding cassette that may cause a jam if operated by the user. For example, in the case of step S104, sheet housing units other than a feeding cassette that may cause a jam if operated by the user are the feeding cassette 4, the feeding cassette 5, and the manual feeding tray 9.

If the identified sheet housing unit is a third stage cassette, that is, the feeding cassette 4, the processing proceeds to step S105. When paper is fed from the feeding cassette 4, if the feeding cassette 2 or 3 positioned at an upper stage thereof is pulled out, the portion 609 of the conveyance path will be severed, and a jam or the like will occur. Therefore, in the present embodiment, in step S105 the main controller 101 executes second control for preventing the user from performing an operation on at least one sheet housing unit other than the identified sheet housing unit. Specifically, the main controller 101 displays a message screen as illustrated in FIG. 5 described above on the operation panel 104 so as to prevent the user from pulling out the feeding cassettes 2 and 3. In the case of step S105, feeding cassettes that may cause a jam if operated by the user are the feeding cassette 2 and the feeding cassette 3. Therefore, the message 501 to be displayed in step S105 is expressed using the identification information of the feeding cassette 2 and identification information of the feeding cassette 3. Further, in the case of step S105, sheet housing units other than a feeding cassette that may cause a jam if operated by the user are the feeding cassette 5 and the manual feeding tray 9. Therefore, when a message indicating that an operation may be executed on a sheet housing unit other than a feeding cassette that may cause a jam if operated by the user is included in the message screen, that message is expressed using identification information of the feeding cassette 5 and identification information of the manual feeding tray 9. After step S105, in step S103, the main controller 101 feeds a sheet from the identified sheet housing unit and performs printing.

If the identified sheet housing unit is a fourth stage cassette, that is, the feeding cassette 5, the processing proceeds to step S106. When paper is fed from the feeding cassette 5, if the feeding cassette 2, 3, or 4, which are positioned at a higher stage, is pulled out, the portion 609 of the conveyance path will be severed, and a jam or the like will occur. Therefore, in the present embodiment, in step S106 the main controller 101 executes third control for preventing the user from performing an operation on at least one sheet housing unit other than the identified sheet housing unit. Specifically, the main controller 101 displays a message screen as illustrated in FIG. 5 described above on the operation panel 104 so as to prevent the user from pulling out the feeding cassettes 2, 3, and 4. In the case of step S106, feeding cassettes that may cause a jam if operated by the user are the feeding cassette 2, the feeding cassette 3, and the feeding cassette 4. Therefore, the message 501 to be displayed in step S106 is expressed using the identification information of the feeding cassette 2 and the identification information of the feeding cassette 3, and identification information of the feeding cassette 4. Further, in the case of step S106, a sheet housing unit other than a feeding cassette that may cause a jam if operated by the user is the manual feeding tray 9. Therefore, when a message indicating that an operation may be executed on a feeding cassette other than a feeding cassette that may cause a jam if operated by the user is included in the message screen, that message is expressed using identification information of the manual feeding tray 9. After step S106, in step S103, the main controller 101 feeds a sheet from the identified sheet housing unit and performs printing.

As described above, according to the present embodiment, when there is a possibility that an event that hinders printing such as a jam will occur, a message screen prompting the user not to pull out a cassette different from a feeding cassette in which a sheet is picked up is displayed. With this, it is possible to prevent a jam or the like from occurring due to an unintentional pull-out operation of a feeding cassette of the user (user operation). Further, in the present embodiment, an example has been described in which information relating to a cassette different from the feeding cassette in which the sheet is picked up is displayed, but information of the feeding cassette in which the sheet is picked up may be displayed.

In the present embodiment, the printing apparatus 1 has been described as a printing apparatus in which printing is performed by an inkjet printing method. However, the printing apparatus 1 may be a printing apparatus in which another printing method such as an electrophotographic method is employed. Further, the processing of FIG. 4 has been described as display control processing for displaying the screen illustrated in FIG. 5. However, the present invention is not limited to display control, and processing for notifying the user of the display contents of FIG. 5 using another form may be performed. For example, notification of the display contents of FIG. 5 may be performed using sound or may be performed by distinguishing display of LED lamps.

Further, in the present embodiment, as control for preventing the user from performing an operation on at least one sheet housing unit other than the sheet housing unit identified in step S101, different control is executed depending on the type of the sheet housing unit identified in step S101. That is, depending on the type of the sheet housing unit identified in step S101, it is controlled whether the first control is executed, the second control is executed or the third control is executed. However, the present invention is not limited to this form, and control for preventing the user from performing an operation on at least one sheet housing unit other than the sheet housing unit identified in step S101 need not be different depending on the type of the sheet housing unit identified in step S101. That is, for example, the same message screen may be displayed in steps S104, S105, and S106. In this case, a message indicating that an operation may be executed on a feeding cassette other than a feeding cassette that may cause a jam if operated by the user need not be included in the message screen. Further, identification information of a feeding cassette that may cause a jam if operated by the user need not be included in the message 501. That is, the message 501 may simply be a message for preventing the user from performing an operation on a feeding cassette.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-166222, filed Sep. 27, 2023, which is hereby incorporated by reference herein in its entirety.

What is claimed is:

1. A printing apparatus comprising:
a plurality of sheet housing units; and
a notification unit configured to, in a case where, in printing, a sheet is supplied from a first sheet housing unit included in the plurality of sheet housing units, make a notification of a message prompting that a user operation not be performed on a second sheet housing unit different from the first sheet housing unit,
wherein in a case where the second sheet housing unit is operated by a user, a path that the second sheet housing unit passes overlaps with at least a portion of a conveyance path of the sheet supplied from the first sheet housing unit.

2. The printing apparatus according to claim 1, further comprising:
a determination unit configured to determine whether the first sheet housing unit is a predetermined sheet housing unit among the plurality of sheet housing units,
wherein in a case where it is determined by the determination unit that the first sheet housing unit is not the predetermined sheet housing unit, the notification unit makes a notification of the message.

3. The printing apparatus according to claim 2,
wherein in a case where it is determined by the determination unit that the first sheet housing unit is the predetermined sheet housing unit, notification by the notification unit is not performed.

4. The printing apparatus according to claim 2, wherein
the plurality of sheet housing units are in a vertical positional relationship with each other, and
the predetermined sheet housing unit includes a sheet housing unit positioned uppermost among the plurality of sheet housing units.

5. The printing apparatus according to claim 4, wherein
the predetermined sheet housing unit includes a manual feeding tray.

6. The printing apparatus according to claim 4, further comprising:
a printing unit which is arranged above the plurality of sheet housing units configured to perform printing on a sheet conveyed from the conveyance path.

7. The printing apparatus according to claim 4, wherein
the second sheet housing unit is above the first sheet housing unit.

8. The printing apparatus according to claim 7, wherein
in a case where there are a plurality of second sheet housing units, the notification unit makes a notification of a message prompting that the user operation not be performed on the plurality of second sheet housing units.

9. The printing apparatus according to claim 1, wherein
the user operation is an operation for pulling out a sheet housing unit from a housing of the printing apparatus.

10. The printing apparatus according to claim 9, wherein
the conveyance path is a space provided near an inner wall of the sheet housing unit.

11. The printing apparatus according to claim 1, wherein
the notification unit displays a screen indicating the message on a display unit.

12. The printing apparatus according to claim 11, wherein
the notification unit displays the screen while printing is being executed.

13. The printing apparatus according to claim 11, wherein
the notification unit ends display of the screen after a predetermined time has elapsed.

14. The printing apparatus according to claim 11, wherein
when an instruction from a user is accepted, the notification unit ends display of the screen.

15. The printing apparatus according to claim 1, wherein
the notification unit makes a notification of a message indicating that an event that hinders an operation of the printing will be caused by the user operation being performed.

16. The printing apparatus according to claim 15, wherein
the event is a jam.

17. The printing apparatus according to claim 1, wherein
the printing apparatus does not include a locking mechanism for prohibiting the user operation.

18. The printing apparatus according to claim 1, wherein
the printing apparatus is a printing apparatus that performs printing using an inkjet printing method.

19. The printing apparatus according to claim 1, wherein
the second sheet housing unit is a sheet housing unit that forms the conveyance path of the sheet supplied from the first sheet housing unit, together with the first sheet housing unit.

20. A method to be executed in a printing apparatus including a plurality of sheet housing units, the method comprising:
in a case where, in printing, a sheet is supplied from a first sheet housing unit included in the plurality of sheet housing units, making notification of a message prompting that a user operation not be performed on a second sheet housing unit different from the first sheet housing unit,
wherein in a case where the second sheet housing unit is operated by a user, a path that the second sheet housing unit passes overlaps with at least a portion of a conveyance path of the sheet supplied from the first sheet housing unit.

21. A non-transitory computer-readable storage medium that stores one or more programs including instructions, which when executed by one or more processors of an information processing apparatus, cause the information processing apparatus to perform a method, the method comprising:
in a case where, in printing, a sheet is supplied from a first sheet housing unit included in a plurality of sheet housing units, making notification of a message prompting that a user operation not be performed on a second sheet housing unit different from the first sheet housing unit,
wherein in a case where the second sheet housing unit is operated by a user, a path that the second sheet housing unit passes overlaps with at least a portion of a conveyance path of the sheet supplied from the first sheet housing unit.
